(19) United States
(12) Patent Application Publication
(10) Pub. No.: US 2006/0221400 A1
(43) Pub. Date: Oct. 5, 2006

(54) Dot pattern forming apparatus and set of FM screen threshold matrices

(75) Inventor: Makoto Sugizaki, Sagamihara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/393,693

(22) Filed: Mar. 31, 2006

(30) Foreign Application Priority Data
Mar. 31, 2005 (JP) 2005-103516

(51) Int. Cl. H04N 1/405

(52) U.S. Cl. 358/3.13

(57) ABSTRACT

A continuous-tone image of uniform density and the thresholds in the FM screen threshold matrices are compared to form dot patterns for CKM-separations. When the dot patterns are transformed by FFT, frequency-domain data are obtained. The obtained frequency-domain data are substantially elliptical figures, and the directions of the major axes of the substantially elliptical figures differ from each other.

### BACKGROUND OF THE INVENTION

1. Field of the Invention

The present invention relates to a dot pattern forming apparatus and a set of FM screen threshold matrices for converting a continuous-tone image in the spatial domain into binary dot patterns in the spatial domain for CMYK (cyan, magenta, yellow and black)-separations by the FM screen threshold matrices for the CMYK-separations. Specifically, the present invention relates to a dot pattern forming apparatus and a set of FM screen threshold matrices which are preferably applicable to a printing-related apparatus (output system) such as a filmsetter, a CTP (Computer To Plate) apparatus, a CTC (Computer To Cylinder) apparatus, a DDCP (Direct Digital Color Proof) system, or an ink jet printer, or an electrophotographic printer, for example. The set of threshold matrices means a combination of at least two threshold matrices for respective color separations.

2. Description of the Related Art

Heretofore, so-called AM (Amplitude Modulation) screens characterized by screen ruling, screen angle, and dot shape, and FM (Frequency Modulation) screens have been used in the art of printing.

A process of generating a threshold matrix for FM screens is disclosed in Japanese Laid-Open Patent Publication No. 8-265566.

According to the disclosed process, an array of elements of a threshold matrix, i.e., an array of thresholds is generated in an ascending order or a descending order by determining threshold positions such that the position of an already determined threshold is spaced the greatest distance from the position of a threshold to be newly determined. The dot pattern of a binary image that is generated using the threshold matrix thus produced has dots which are not localized. Even when a dot pattern is generated using a plurality of such threshold matrices that are juxtaposed, the dot pattern does not suffer a periodic pattern produced by the repetition of threshold matrices.

A plurality of patent documents given below are relevant to the generation of a threshold matrix.

Japanese Patent No. 3400316 discloses a method of correcting halftone image data by extracting a pixel having a weakest low-frequency component of a certain dot pattern, from white pixels (unblackened pixels), and a pixel having a strongest low-frequency component of the dot pattern, from blackened pixels, and switching around the extracted white and blackened pixels. Thus, the dot pattern is intended to be smoothed or leveled.

Japanese Laid-Open Patent Publication No. 2001-292317 reveals a process of determining threshold positions in a threshold matrix such that a next blackened pixel is assigned to a position having a weakest low-frequency component of the threshold matrix.

Japanese Laid-Open Patent Publication No. 2002-368995 shows a process of determining threshold positions in a threshold matrix such that when an array of thresholds in the threshold matrix has been determined up to a certain gradation and a threshold position for a next gradation is to be determined, blackened pixels are assigned to positions for not strengthening a low-frequency component.

Japanese Laid-Open Patent Publication No. 2002-369005 discloses a process of generating a threshold matrix according to the process shown in Japanese Patent No. 3400316, Japanese Laid-Open Patent Publication No. 2001-292317 or Japanese Laid-Open Patent Publication No. 2002-368995, based on an ideal dot pattern at a certain gradation which is given.

Generally, the formation of color images using a screen such as an FM screen is conducted as follows. A continuous tone image is converted into binary dot patterns in the spatial domain for CMYK-separations by FM screen threshold matrices for the CMYK-separations, and each of the dot patterns is overlaid for forming a color image (see Japanese Laid-Open Patent Publication No. 10-505473 (PCT Application), page 7, the last line to page 8, line 3, FIGS. 1b and 6b; and Japanese Laid-Open Patent Publication No. 2002-540735 (PCT Application), paragraphs [0078] through [0080], FIG. 15c).

In Japanese Patent No. 3400316 and Japanese Patent Laid-Open Patent Publication No. 2001-292317, a screen is generated by a function of distance, or by using the characteristic of an elliptical ring. Then, it has been found that the graininess (grainness) in an image may be reduced. These documents, however, merely disclose the reduction of graininess in an image of a single separation, i.e., a monochrome screen.

However, it has been found that the graininess may be recognized when a color image is reproduced by overlaying a plurality of color separations, even if the graininess is reduced in an image of a single separation.

### SUMMARY OF THE INVENTION

It is an object of the present invention to provide a dot pattern forming apparatus and a set of threshold matrices which are capable of reducing the graininess in a color image formed by overlaying (superimposing) FM screen dot patterns for color separations.

According to the present invention, there is provided a dot pattern forming apparatus for converting a continuous-tone image into binary dot patterns for color separations of a multiple color image by FM screen threshold matrices for the separations of the multiple color image, wherein when a middle tone image of uniform density is converted into the binary dot patterns for the separations of the multiple color image by the FM screen threshold matrices for the separations of the multiple color image, and when each of dot patterns for at least two separations in the converted binary dot patterns is FFTed from an image in spatial domain to a two-dimensional image in frequency domain, the transformed two-dimensional images for at least the two separations are substantially elliptical figures, each of the substantially elliptical figures includes an ellipse and a figure that is not a circle or a rectangle but is symmetrical with respect to straight lines of major and minor axes orthogonal to each other and that has a smooth curvature along the entire periphery of the figure, and the directions of the major axes of the substantially elliptical figures for at least the two separations differ from each other.

The middle tone is defined as a gradation in an image between highlight and shadow, which has a blackening ratio (dot percentage) of 10% through 90%. Preferably, the middle tone refers to the gradation having a dot percentage of 50%.

In this case, the color of the multiple color image may be formed by C, M, Y and K. In the substantially elliptical figures for CMYK-separations, it is preferable that the angles between the major axes of the substantially elliptical figures for the CMK-separations are 30°.

Alternatively, it is preferable that the angles between the major axes of the substantially elliptical figures for the CMYK-separations are 22.5°.

It is preferable that at least the two separations are a C-separation and an M-separation. In this case, it is further preferable that the major axes of the substantially elliptical figures for the C-separation and the M-separation are orthogonal to each other.

Furthermore, it is preferable that the substantially elliptical figures are congruent with each other.

According to the present invention, there is provided a dot pattern forming apparatus for converting a continuous-tone image into binary dot patterns for CMYK-separations by FM screen threshold matrices for the CMYK-separations, wherein when a middle tone image of uniform density is converted into the binary dot patterns for the CMYK-separations by the FM screen threshold matrices for the CMYK-separations, and when each of the binary dot patterns for the C-separation and the M-separation in the converted binary dot patterns is FFTed from an image in spatial domain to a two-dimensional image in frequency domain, the transformed two-dimensional images for the CM-separations are substantially elliptical figures, each of the substantially elliptical figures includes an ellipse and a figure that is not a circle or a rectangle but is symmetrical with respect to straight lines of major and minor axes orthogonal to each other and that has a smooth curvature along the entire periphery of the figure, and the directions of the major axes of the substantially elliptical figures for the CM-separations differ from each other.

The middle tone is defined as a gradation in an image between highlight and shadow, which has a blackening ratio (dot percentage) of 10% through 90%. Preferably, the middle tone refers to the gradation having a dot percentage of 50%.

In this case, it is preferable that the major axes of the substantially elliptical figures for the C-separation and the M-separation are orthogonal to each other.

Further, it is preferable that the substantially elliptical figures are congruent with each other.

According to the present invention, there is provided a dot pattern forming apparatus for converting a continuous-tone image into binary dot patterns for CMYK-separations by FM screen threshold matrices for the CMYK-separations, wherein when a middle tone image of uniform density is converted into the binary dot patterns for the CMYK-separations by the FM screen threshold matrices for the CMYK-separations, and when each of the converted binary dot patterns is FFTed from an image in spatial domain to a two-dimensional image in frequency domain, the transformed two-dimensional images for the CMYK-separations are substantially elliptical figures, each of the substantially elliptical figures includes an ellipse and a figure that is not a circle or a rectangle but is symmetrical with respect to straight lines of major and minor axes orthogonal to each other and that has a smooth curvature along the entire periphery of the figure, and the directions of the major axes of the substantially elliptical figures for the CMYK-separations differ from each other.

In this case, in the substantially elliptical figures for CMYK-separations, it is preferable that the angles between the major axes of the substantially elliptical figures for the CMK-separations are 30°.

Alternatively, it is preferable that the angles between the major axes of the substantially elliptical figures for the CMYK-separations are 22.5°.

Further, it is preferable that the major axes of the substantially elliptical figures for the CM-separations are orthogonal to each other.

Furthermore, it is preferable that the substantially elliptical figures are congruent with each other.

According to the present invention, there is provided a set of FM screen threshold matrices for color separations of a multiple color image, for converting a continuous-tone image into binary dot patterns for the separations of the multiple color image, wherein when a middle tone image of uniform density is converted into the binary dot patterns for the separations of the multiple color image by the FM screen threshold matrices, and when each of dot patterns for at least two separations in the converted binary dot patterns is FFTed from an image in spatial domain to a two-dimensional image in frequency domain, the transformed two-dimensional images for at least the two separations are substantially elliptical figures, each of the substantially elliptical figures includes an ellipse and a figure that is not a circle or a rectangle but is symmetrical with respect to straight lines of major and minor axes orthogonal to each other and that has a smooth curvature along the entire periphery of the figure, and the directions of the major axes of the substantially elliptical figures for at least the two separations differ from each other.

According to the present invention, there is provided a set of FM screen threshold matrices for CMYK-separations, for converting a continuous-tone image into binary dot patterns for the CMYK-separations, wherein when a middle tone image of uniform density is converted into the binary dot patterns for the CMYK-separations by the FM screen threshold matrices, and when each of the converted binary dot patterns is FFTed from an image in spatial domain to a two-dimensional image in frequency domain, the transformed two-dimensional images for the CMYK-separations are substantially elliptical figures, each of the substantially elliptical figures includes an ellipse and a figure that is not a circle or a rectangle but is symmetrical with respect to straight lines of major and minor axes orthogonal to each other and that has a smooth curvature along the entire periphery of the figure, and the directions of the major axes of the substantially elliptical figures for the CMYK-separations differ from each other.

With the present invention, the graininess in a color image formed by overlaying (superimposing) FM screen dot patterns for color separations can be reduced.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a threshold matrix generating system to which a process of generating a threshold matrix according to an embodiment of the present invention is applied;

FIG. 2 is a flowchart of an overall sequence of the process of generating a threshold matrix which is carried out by the threshold matrix generating system shown in FIG. 1;

FIG. 3 is a diagram of a white noise pattern generated at a dot percentage of 50% by 1×1 pixel FM-screened dots;

FIG. 4 is a diagram of a transforming process by FFT and a bandpass filtering process, for the white noise pattern;

FIG. 5 is a diagram of a binary image (a dot pattern) in the spatial domain obtained by transforming frequency-domain data in FIG. 4 by IFFT;

FIG. 6 is a diagram of the frequency-domain data for an M-separation, in which the flattening is 1.5 and the slope is 22.5°;

FIG. 7 is a diagram of the dot pattern for the M-separation obtained by transforming the frequency-domain data in FIG. 6 by IFFT;

FIG. 8 is a diagram of the frequency-domain data for a C-separation, in which the flattening is 1.5 and the slope is 45°;

FIG. 9 is a diagram of the dot pattern for the C-separation obtained by transforming the frequency-domain data in FIG. 8 by IFFT;

FIG. 10 is a diagram of the frequency-domain data for a K-separation, in which the flattening is 1.5 and the slope is 67.50;

FIG. 11 is a diagram of the dot pattern for the K-separation obtained by transforming the frequency-domain data in FIG. 10 by IFFT;

FIG. 12 is a diagram of a dot pattern when the dot patterns for the CMYK-separations are superimposed;

FIG. 13 is a diagram of a dot pattern as a comparative example when other dot patterns for the CMYK-separations are superimposed;

FIG. 14 is a diagram of the frequency-domain data for the M-separation, in which the flattening is 1.5 and the slope is 90°;

FIG. 15 is a diagram of the dot pattern for the M-separation obtained by transforming the frequency-domain data in FIG. 14 by IFFT;

FIG. 16 is a diagram of a dot pattern when the dot patterns for the CM-separations according to another embodiment are superimposed;

FIG. 17 is a diagram of a dot pattern as a comparative example when other dot patterns for the CM-separations are superimposed;

FIG. 18 is a diagram of the frequency-domain data for the C-separation, the M-separation and K-separation;

FIG. 19 is a diagram of the frequency-domain data for the C-separation, the M-separation, the Y-separation and the K-separation, with some gaps in the frequency-domain data; and

FIG. 20 is a block diagram of a printing/platemaking system incorporating threshold matrices generated by a threshold matrix generating apparatus.

### DESCRIPTION OF THE PREFERRED EMBODIMENTS

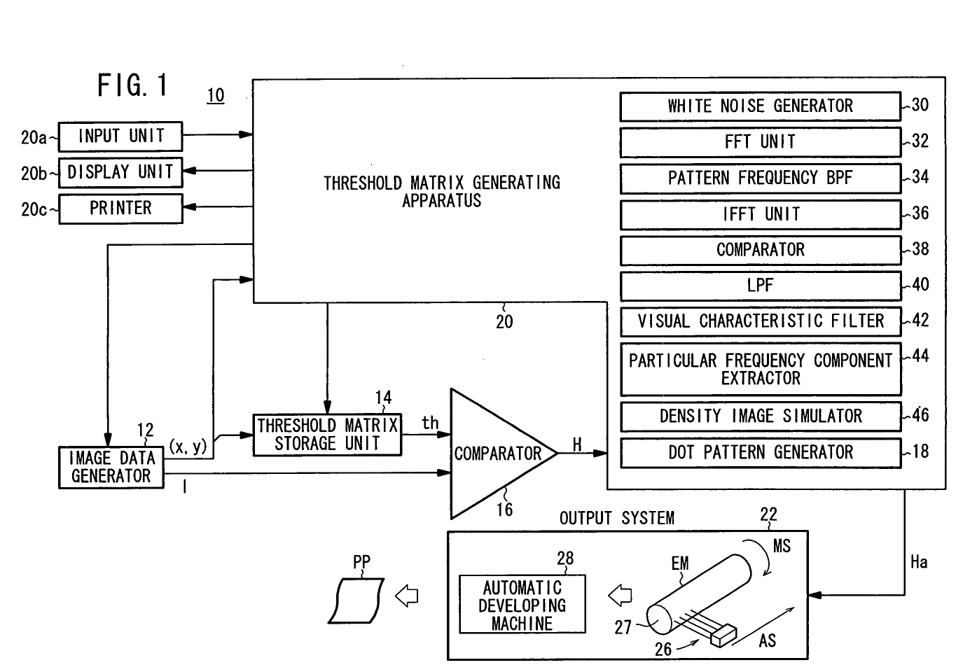

FIG. 1 illustrates a basic arrangement of a threshold matrix (a set of threshold matrices) generating system 10 into which a dot pattern forming apparatus according to the present invention is incorporated.

The dot pattern forming apparatus in the present embodiment comprises a threshold matrix storage unit 14, a comparator 16, and a dot pattern generator 18.

The image data generator 12 generates continuous-tone image data (data I) captured by an input unit 20a. Further, when a threshold matrix is generated, the image data generator 12 generates arbitrary image data I including a test image made up of pixels of uniform density (an image of uniform density of highlight, a middle tone, or shadow) and also generates a two-dimensional address (x, y) of the image data I.

Basically, the threshold matrix generating system 10 has the image data generator 12, the threshold matrix storage unit 14 for storing a plurality of threshold matrices TM and outputting a threshold th read by the address (x, y), the comparator 16 for comparing the threshold th and the image data I and outputting binary image data H, a threshold matrix generating apparatus 20 including a dot pattern generator 18 for generating dot pattern data Ha corresponding to the binary image data H output from the comparator 16, the threshold matrix generating apparatus 20 serving to determine a threshold array (threshold positions) of the threshold matrices TM such that a dot pattern represented by the dot pattern data Ha will be a desired dot pattern, and an output system 22 for forming the dot pattern corresponding to the dot pattern data Ha on a film, a printing plate PP, or a printed material.

The threshold matrix storage unit 14 comprises a recording medium such as a hard disk or the like. The image data generator 12, the comparator 16, the dot pattern generator 18, and the threshold matrix generating apparatus 20 may comprise function realizing means that are achieved when a program stored in a personal computer (including a CPU, a memory, an input unit 20a such as a keyboard and a mouse, and an output unit such as a display unit 20b and a printer 20c) is executed by the computer. The function realizing means of the threshold matrix generating apparatus 20 may be implemented by some hardware instead of software.

In the present embodiment, the output system 22 basically comprises a CTP (Computer To Plate) apparatus having an exposure unit 26 and a drum 27 with printing plate materials EM wound thereon. The exposure unit 26 applies a plurality of laser beams (recording beams), which are turned on and off for each pixel depending on the dot pattern data Ha, to the printing plate materials EM on the drum 27 that is being rotated in a main scanning direction MS by a main scanning motor (not shown) at a high speed, while the exposure unit 26 is being moved in an auxiliary scanning direction AS along the axis of the drum 27 by an auxiliary scanning motor (not shown). At this time, a dot pattern representing a two-dimensional image as a latent image is formed on each of the printing plate materials EM. The laser beams applied to the printing plate materials EM may be in several hundred channels.

The printing plate materials EM (usually, four printing plate materials for C, M, Y, K printing plates) on which the dot patterns are formed as latent images are developed by an automatic developing machine 28, producing printing plates PP for CMYK-separations with visible dot patterns formed thereon. Each of the produced printing plates PP is mounted on a printing press (described later), and inks are applied to the mounted printing plates PP.

When the inks applied to the printing plates PP are transferred to a printing sheet as a recording medium such as a photographic sheet or the like and the colors are superimposed, a desired printed material comprising a color image formed on the printing sheet is obtained.

As mentioned later, the output system 22 is not limited to the scanning exposure apparatus employing laser beams, but may be an apparatus for forming an image on a film, a printing plate, or a printed material according to a planar exposure process or an ink jet process, or a CTC printing machine.

The threshold array of the threshold matrices TM stored in the threshold matrix storage unit 14 can be recorded and carried around in a portable recording medium which is a packaged medium such as a DVD, a CD-ROM, a CD-R, a semiconductor memory, or the like.

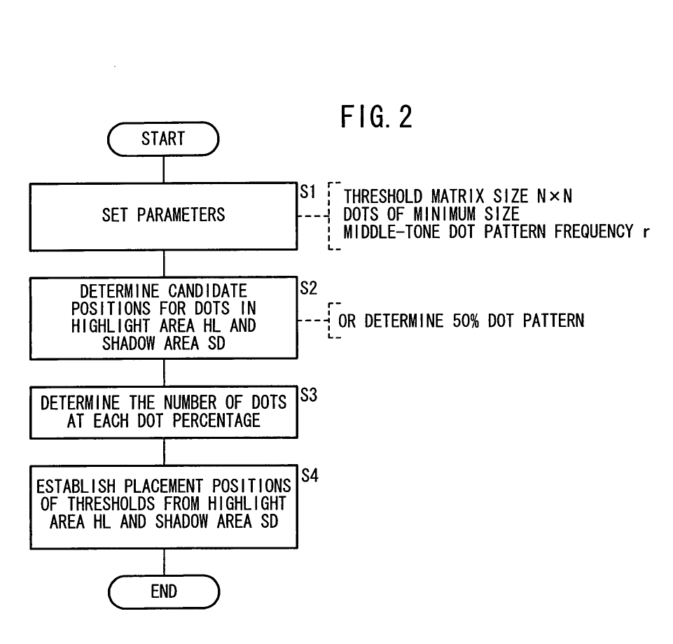

A process of generating a threshold matrix using the threshold matrix generating system 10 shown in FIG. 1 will be described below with reference to a flowchart of FIG. 2. The process shown in FIG. 2 is based on a program which is mainly executed by the threshold matrix generating apparatus 20.

In step S1 shown in FIG. 2, three parameters are set. The first parameter represents the size of a threshold matrix TM to be stored in the threshold matrix storage unit 14, i.e., the size N×N of a threshold matrix TM which contains N×N thresholds corresponding to N×N pixels. The threshold matrix TM contains thresholds th ranging from 0 to thmax at respective positions (elements) determined by addresses (x, y). The maximum threshold thmax has a value that is set to “255” for a system having the 8-bit gradation and “65535” for a system having the 16-bit gradation. The size N×N of a square threshold matrix will be described below. However, the present invention is also applicable to the size N×M of an elongate rectangular threshold matrix. Actually, a plurality of threshold matrices TM having the same threshold array and matrix size N×N and laid out as tiles (referred to as a superthreshold matrix STM) are used depending on the size of an image to be processed. The thresholds th of the threshold matrix TM are determined in view of the threshold array of the entire superthreshold matrix STM.

In the present embodiment, the size of a pixel that can be output from the output system 22 is represented by 10 μm×10 μm, which corresponds to a 1×1-pixel dot or 1 pixel. The size 10 μm×10 μm is a minimum unit that can be controlled by the exposure unit 26 for recording image data on the printing plate materials EM.

The second parameter represents the number of pixels that make up a dot of a minimum size which can stably be output from the output system 22, or stated otherwise, can stably be formed on the printing plates PP which are output from the output system 22. The dot of a minimum size may be set to a 1-pixel dot (the number of pixels that make up a dot of a minimum size is one), a 2-pixel dot, a 3-pixel dot, a 2×2-pixel (the number of pixels that make up a dot of a minimum size is four) dot, a 2×3-pixel (6-pixel) dot, a 3×3-pixel (9-pixel) dot, etc. In the present embodiment, it is assumed that a dot of a minimum size that can stably be formed on the printing plates PP (in reality, the printed material) is a 2×2-pixel dot whose dot size is represented by 2×2=4 pixels. That is, FM screens made up of 2×2-pixels are assumed.

The third parameter represents the pattern frequency at a predetermined dot percentage (also referred to as density percentage) in intermediate or middle tones having a dot percentage in the range from 10% to 50% (also from 50% to 90%), i.e., the pattern frequency r of a middle tone dot pattern. The pattern frequency r of a middle tone dot pattern represents the peak spatial frequency fpeak c/mm of a dot pattern in a middle tone.

In reality, the peak spatial frequency fpeak is concerned with the reproduction of image details, and also affects image quality in terms of graininess etc. In the present embodiment, the pattern frequency r is set to a visually sufficiently small value of 20 c/mm, i.e., 508 (20×25.4) LPI (Line Per Inch) (fpeak=r=20 c/mm).

In step S2, a dot candidate position in a highlight area HL and a dot candidate position in a shadow area SD are determined to provide the pattern frequency r in a middle tone.

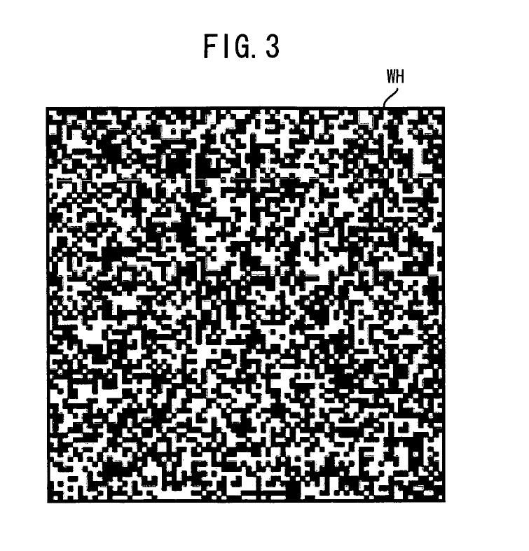

First, as shown in FIG. 3, a white noise generator 30 generates a white noise pattern WH at a dot percentage of 50% having the same size N×N as the size N×N of the threshold matrix TM. The white noise pattern WH is an image where 1-pixel dots are randomly positioned in a spatial domain. The white noise pattern WH can be generated so as to have desired values in a middle tone having a dot percentage in the range from 10% to 90%.

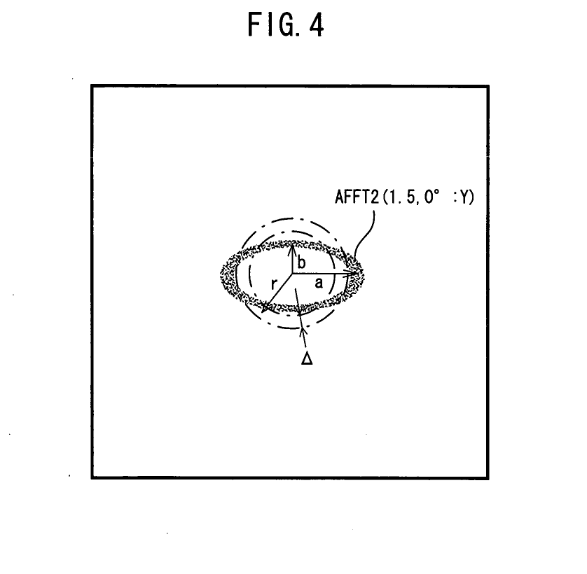

Second, the white noise pattern WH is FFTed by an FFT (Fast Fourier Transform) unit 32 to be converted into a frequency-domain pattern. Then, the pattern is subjected to a bandpass filtering process at the pattern frequency r (±Δ), the flattening (=(long radius−short radius)/long radius) of 1.5, and the angle of 0° by a pattern frequency bandpass filter (pattern frequency BPF) 34. Then, as shown in FIG. 4, frequency-domain data AFFT2 having an elliptical ring shaped area can be obtained. The frequency-domain data AFFT2 has the pattern frequency r (a>r>b) and the flattening (ellipticity) f=1.5 (f=(a−b)/a). The frequency-domain data AFFT2 having an elliptical ring shape with the flattening f and a slope θ for color separations “Colors” will be indicated as AFFT2(f, θ: Colors). For example, the frequency-domain data AFFT2 in FIG. 4 is represented as AFFT2(1.5, 0°: Y). “Y” means that the frequency-domain data are prepared for the color separation Y. In FIG. 4, the frequency-domain data having a circular ring shape (f=0) are shown in dot-dash lines.

Third, the frequency-domain data AFFT2(1.5, 0°: Y) is IFFTed by an IFFT (Inverse Fast Fourier Transform) unit 36, producing spatial-domain data of a continuous-tone image (not shown).

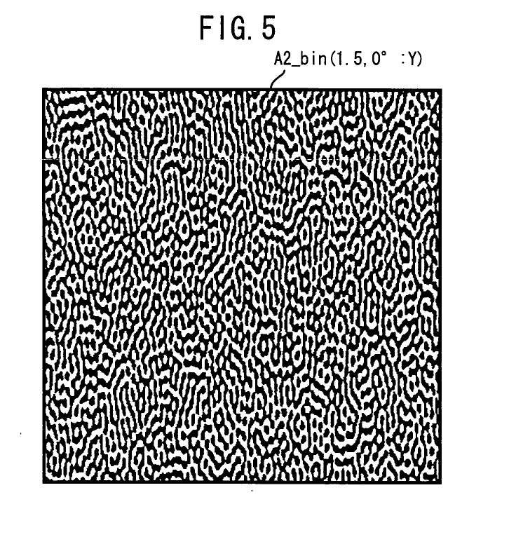

Fourth, the value of each of the pixels of the spatial-domain data is compared with a central gradation value (e.g., 127 if the maximum gradation is 255) by a comparator 38, generating a dot pattern A2_bin(1.5, 0°: Y) as binary data (for A2_bin(f, θ: Colors)), as shown in FIG. 5. “Y” means that the binary image is prepared for generating a threshold matrix for the color separation Y.

Of the dot pattern A2_bin(1.5, 0°: Y) for the Y-separation, blackened portions (areas) serve as dot candidate positions in highlight areas HL and white portions (areas) serve as dot candidate positions in shadow areas SD.

The dot pattern A2_bin(1.5, 0°: Y) for the Y-separation shows dot candidate positions in the highlight areas HL or the shadow areas SD, and the dot pattern at the dot percentage of 50% may not always be the dot pattern A2_bin(1.5, 0°: Y) for the Y-separation. This allows the dot pattern to be modified freely for optimization if it is not the optimal pattern at the dot percentage of 50%.

If any specific dot pattern is desired at the dot percentage of 50%, or if the optimal dot pattern at the dot percentage of 50% can be obtained when a dot pattern corresponding to the dot pattern A2_bin(1.5, 0°: Y) for the Y-separation is adjusted, such dot pattern can be set as a dot pattern at the dot percentage of 50%.

Then, in step S3, the number Dn of dots of a minimum size (also referred to as the number of dots of a new minimum size dots or the number of new dots of a minimum size) to be newly set at a present dot percentage is determined with respect to the dot percentage for which a dot pattern has been determined. The number Dn(P) of new dots of a minimum size to be established at each dot percentage P % is expressed as Dn(P)=Ds(P)−Ds(P−1) where Ds(P) represents the number of accumulated dots (accumulated values) at each dot percentage P %.

Specifically, in step S3, when candidate positions for dots are successively determined as the dot percentage is incremented, the number Dn(P) of dots of a minimum size to be newly established at a present dot percentage P is determined with respect to the preceding dot percentage P-1 for which a dot pattern has already been determined.

When a dot pattern has a dot percentage P with respect to the size N×N of a threshold matrix TM, the total number of blackened pixels in the dot pattern corresponding to the size N×N of the threshold matrix TM is calculated as N×N×P/100. If all the dots of a dot pattern comprise only dots of a minimum size as 2×2(n=4)−pixel dots, then since the number of new dots of a minimum size at each dot percentage P is expressed as Ds(P)=(N×N×P/100)/n, it is given as (N×N×P/100)/n(n=4).

At this time, the number Dn(P) of dots of a minimum size to be newly established at this dot percentage P is expressed as Dn(P)=Ds(P)−Ds(P−1)=(N×N/100)/n.

Then, thresholds th are alternately determined successively in ascending and descending orders in the highlight area HL and the shadow area SD in step S4. The positions of the thresholds th are selected from the binary data A2_bin(1.5, 0°: Y) shown in FIG. 5.

The method of determining the thresholds th of the threshold matrix (in this case, for Y-separation) is omitted here since it is known from the art disclosed in Japanese Patent No. 3400316, Japanese Laid-Open Patent Publication No. 2001-292317, Japanese Laid-Open Patent Publication No. 2002-368995 and Japanese Laid-Open Patent Publication No. 2002-369005.

In a similar manner, the threshold matrices for MCK-separations other that the Y-separation are generated. In this case, it is supposed that the data at the slope θ of 0° (the frequency-domain data AFFT2(1.5, 0°: Y) shown in FIG. 4, and the dot pattern A2_bin(1.5, 0°: Y) shown in FIG. 5) are used for the Y-separation. Then, the other three color separations are superimposed thereon, with the data at several slopes θ. Finally, it has been found that the graininess or grainness in the obtained image is reduced when the frequency-domain data and the binary data for the M-separation have the slope θ of 22.5°, the frequency-domain data and the binary data for the C-separation have the slope θ of 45°, and the frequency-domain data and the binary data for the K-separation have the slope θ of 67.5°.

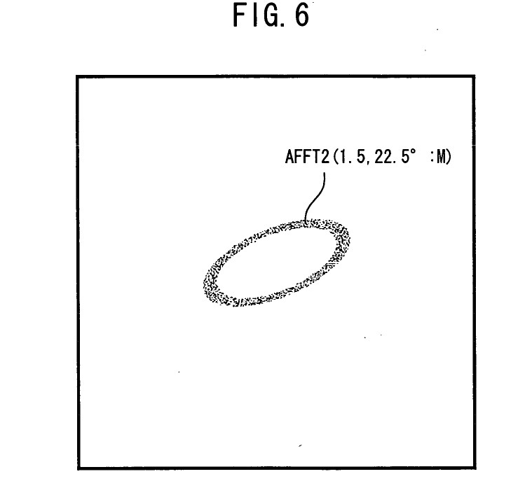

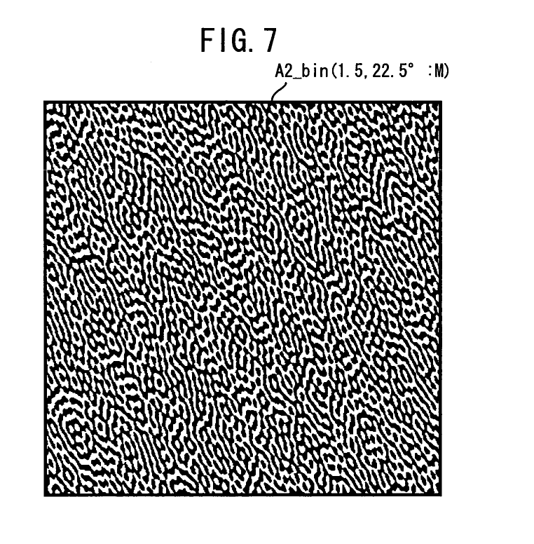

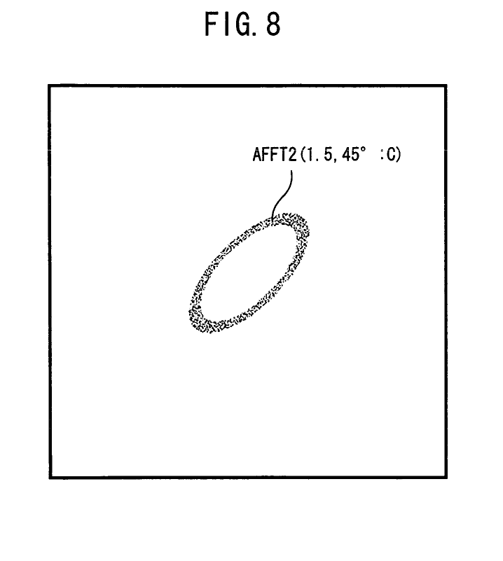

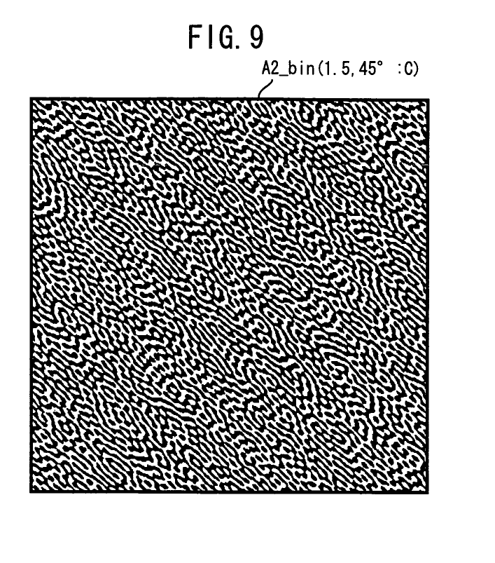

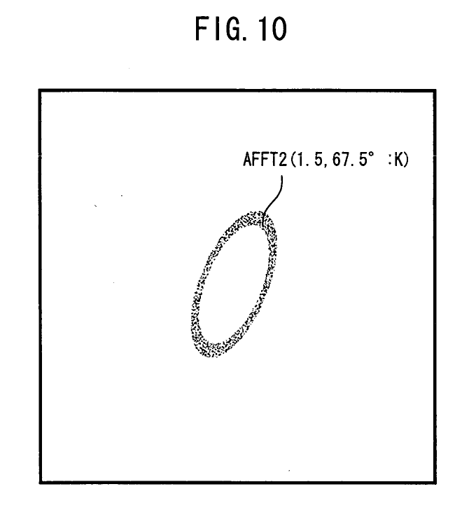

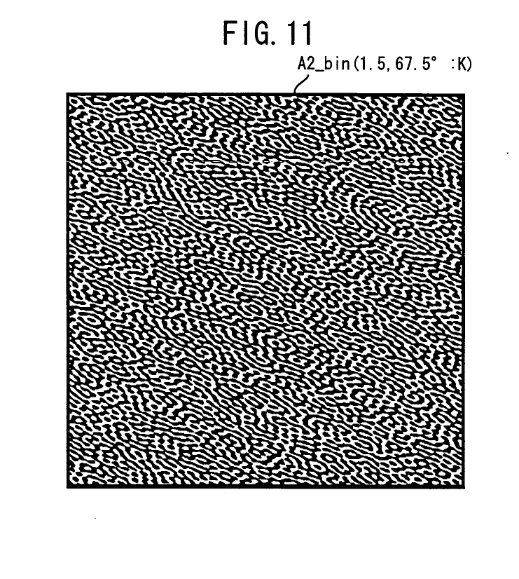

FIG. 6 illustrates the frequency-domain data AFFT2 (1.5, 22.5°: M) for the M-separation. FIG. 7 illustrates the dot pattern A2_bin(1.5, 22.5°: M) for the M-separation. FIG. 8 illustrates the frequency-domain data AFFT2 (1.5, 45°: C) for the C-separation. FIG. 9 illustrates the dot pattern A2_bin(1.5, 45°: C) for the C-separation. FIG. 10 illustrates the frequency-domain data AFFT2 (1.5, 67.5°: K) for the K-separation. FIG. 11 illustrates the dot pattern A2_bin(1.5, 67.5°: K) for the K-separation.

Each of the data will be obtained as follows. The image data generator 12 generates middle tone image data I (at a dot percentage of 50% in this example) with uniform density. Using the respective FM screen threshold matrices for the CMYK-separations stored in the threshold matrix storage unit 14, the image data I are converted into the respective dot patterns as binary images for the CMYK-separations by the comparator 16 and the dot pattern generator 18. Then, the dot pattern A2_bin(1.5, 0°: Y) for the Y-separation in FIG. 5, the dot pattern A2_bin(1.5, 22.5°: M) for the M-separation in FIG. 7, the dot pattern A2_bin(1.5, 45°: C) for the C-separation in FIG. 9, and the dot pattern A2_bin(1.5, 67.5°: K) for the K-separation in FIG. 11 are obtained.

Then, the dot pattern A2_bin(1.5, 0°: Y) for the Y-separation in FIG. 5, the dot pattern A2_bin(1.5, 22.5°: M) for the M-separation in FIG. 7, the dot pattern A2_bin(1.5, 45°: C) for the C-separation in FIG. 9, and the dot pattern A2_bin(1.5, 67.5°: K) for the K-separation in FIG. 11, each in the spatial domain, are FFTed into the two-dimensional images in the frequency domain.

The transformed two-dimensional images for the respective CMYK-separations are a substantially elliptical figure as shown in FIGS. 4, 6, 8 and 10, respectively. Each of the substantially elliptical figures includes an ellipse defined by an equation of {(x²/a²)+(y²/b²)}=1 (a≠b), and a figure that is not a circle or a rectangle but is symmetrical with respect to a straight line of each of major and minor axes orthogonal to each other and that has a smooth curvature along the entire periphery of the figure. The directions (angles of the major axis) of the substantially elliptical figures for the CMYK-separations differ by 22.5°, respectively. The substantially elliptical figures are congruent with each other.

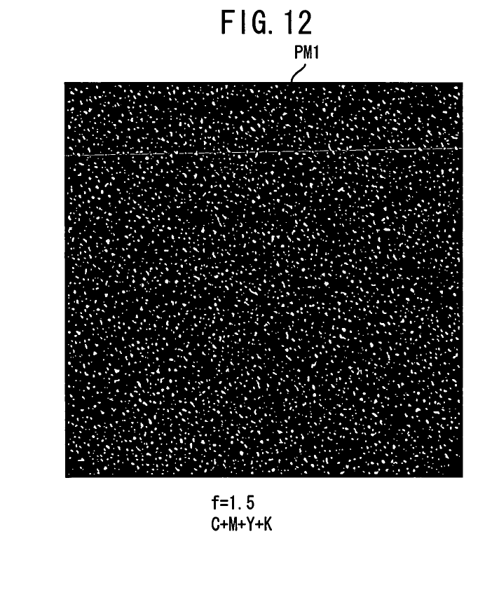

FIG. 12 illustrates an FM screen color image PM1 when the dot patterns A2_bin(1.5, θ: Colors) for the YMCK-separations shown in FIGS. 5, 7, 9, and 11 are superimposed. In this case, the dot patterns A2_bin(1.5, θ: Colors) are A2_bin(1.5, 0°: Y), A2_bin(1.5, 22.5°: M), A2_bin(1.5, 45°: C), and A2_bin(1.5, 67.5°: K), each of which is shown as an ellipse and has the flattening (ellipticity) f of 1.5.

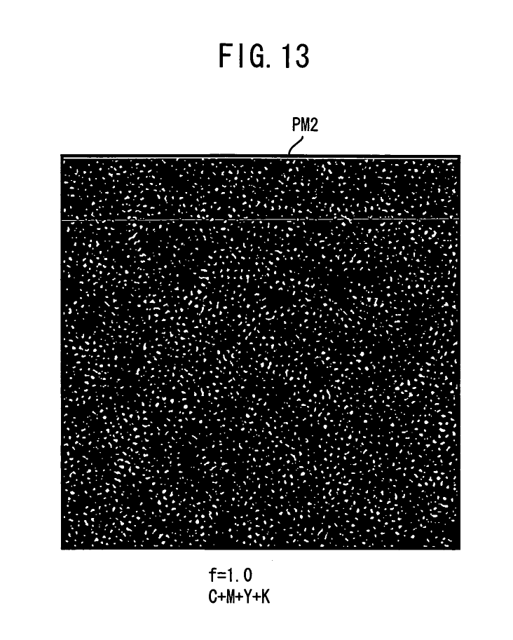

As a comparative example, FIG. 13 illustrates an arbitrary FM screen color image PM2 when the dot patterns A2_bin(0, θ: Colors) for the YMCK-separations are superimposed. In this case, the dot patterns A2_bin(0, θ: Colors) are A2_bin(0, 0°: Y), A2_bin(0, 22.5°: M), A2_bin(0, 45°: C), and A2_bin(0, 67.5°: K), each of which is shown as a circle and has the flattening f of 0.

As compared with the color image PM2 in FIG. 13, it can be understood that the graininess in the color image PM1 in FIG. 12, which is formed by superimposing the dot patterns for the YMCK-separations, is reduced.

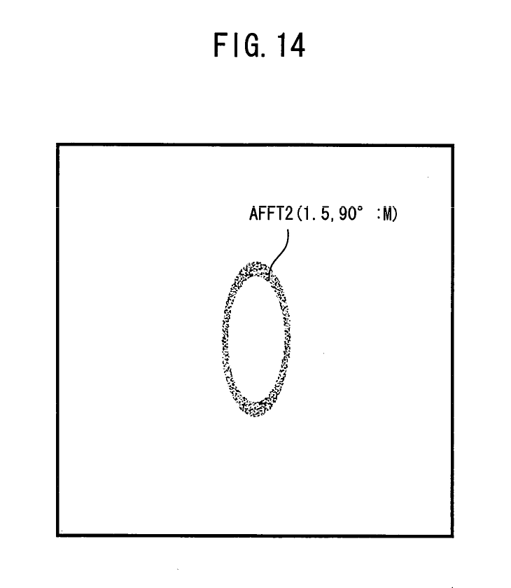

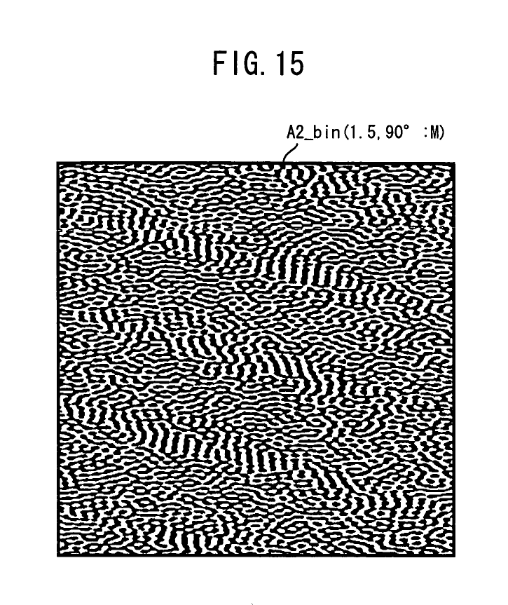

When the colors C and M are mainly used in an FM screen color image, dot patterns for the C-separation and M-separation may be selected as follows. The dot pattern for the C-separation may be the same as the dot pattern for the Y-separation shown in FIG. 5. That is, the frequency-domain data AFFT2 (1.5, 0°: C) are used, which represent the same figure as the frequency-domain data for the Y-separation shown in FIG. 4. Then, the dot pattern A2_bin(1.5, 0°: C) is obtained. For the M-separation, the frequency-domain data AFFT2 (1.5, 90°: M) shown in FIG. 14 may be used, which are orthogonal to the frequency-domain data AFFT2 (1.5, 0°: C). Then, the corresponding dot pattern A2_bin(1.5, 90°: M) shown in FIG. 15 is obtained.

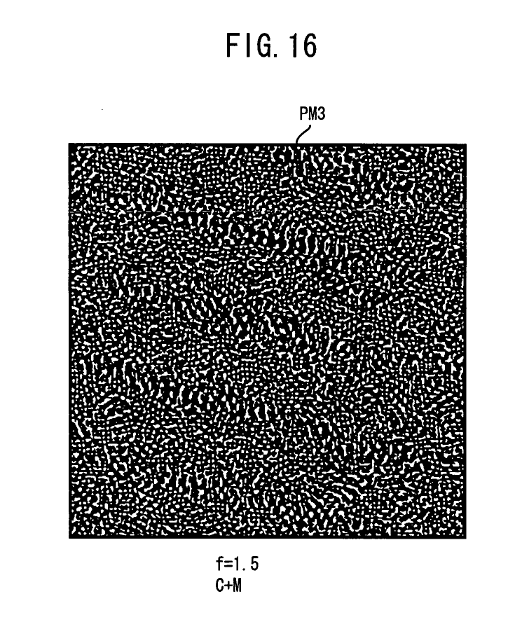

FIG. 16 illustrates an FM screen color image PM3 when the dot patterns A2_bin(1.5, θ: Colors) for the CM-separations shown in FIGS. 5 and 15 are superimposed. In this case, the dot patterns A2_bin(1.5, θ: Colors) are A2_bin(1.5, 0°: C) and A2_bin(1.5, 90°: M), each of which is shown as an ellipse and has flattening f of 1.5.

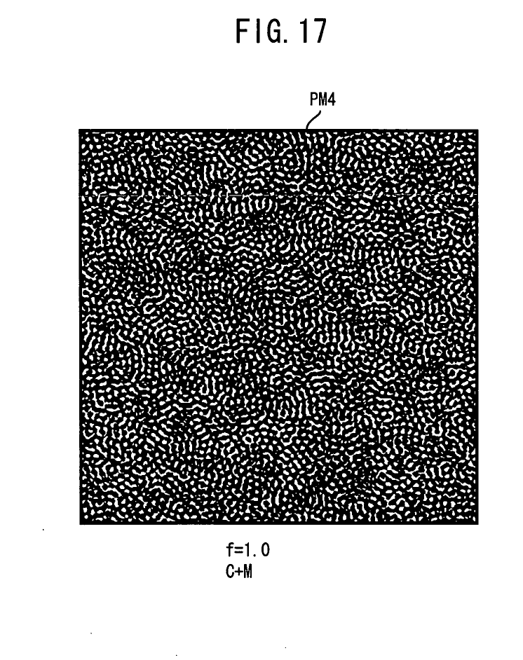

As a comparative example, FIG. 17 illustrates an FM screen color image PM4 when the dot patterns A2_bin(0, θ: Colors) for the CM-separations are superimposed. In this case, the dot patterns A2_bin(0, θ: Colors) are A2_bin(0, 0°: C) and A2_bin(0, 90°: M), each of which is shown as a circle and has flattening f of 0.

As compared with the color image PM4 in FIG. 17, it can be understood that the graininess in the color image PM3 in FIG. 16, which is formed by superimposing the dot patterns for the CM-separations, is reduced.

As shown in the above embodiment, a continuous-tone image is captured by the input unit 20a. The dot pattern forming apparatus converts the captured continuous-tone image into binary dot patterns for separations of a multiple color image by FM screen threshold matrices for the separations of the multiple color image. The multiple color image is an image including two or more colors. The FM screen threshold matrices are stored in the threshold matrix storage unit 14. The image data generator 12 generates a middle tone image of uniform density. The comparator 16 compares the middle tone image of uniform density and the thresholds in the FM screen threshold matrices for the separations of the multiple color image to obtain the binary image data H. The dot pattern generator 18 converts the obtained binary image data H into the binary dot patterns for the separations of the multiple color image. Each of dot patterns for at least two color separations in the converted binary dot patterns is FFTed (transformed using fast Fourier transform) from an image in the spatial domain to a two-dimensional image in the frequency domain. The dot patterns for at least the two color separations are, for example, a dot pattern for the C-separation and a dot pattern for the M-separation. The colors C and M are usually main colors in a color image. Then, the transformed two-dimensional images in the frequency domain for at least the two separations are substantially elliptical figures. Also, the directions of the major axes of the substantially elliptical figures for at least the two color separations differ from each other. Specifically, the transformed two-dimensional images for at least the two color separations are shown as the frequency-domain data AFFT2(1.5, 22.5°: M) in FIG. 6 and the frequency-domain data AFFT2(1.5, 45°: C) in FIG. 8; or the frequency-domain data AFFT2(1.5, 0°: Y) in FIG. 4 and the frequency-domain data AFFT2(1.5, 90°: M) in FIG. 14, for example. The two substantially elliptical figures are congruent with each other. In FIGS. 4 and 14, the directions of the major axes of the substantially elliptical figures for at least the two color separations are orthogonal to each other. In FIGS. 6 and 8, the directions of the major axes of the substantially elliptical figures for at least the two color separations differ from each other by 22.5°.

In this case, the middle tone is defined as a gradation in an image between highlight and shadow, which has a blackening ratio (dot percentage) of 10% through 90%. Preferably, the middle tone refers to the gradation having a dot percentage of 50%.

Further, as shown in the above embodiment, a continuous-tone image is captured by the input unit 20a. The dot pattern forming apparatus converts the captured continuous-tone image into binary dot patterns for CMYK-separations by FM screen threshold matrices for the CMYK-separations. The FM screen threshold matrices are stored in the threshold matrix storage unit 14. The image data generator 12 generates a middle tone image of uniform density. The comparator 16 compares the middle tone image of uniform density and the thresholds in the FM screen threshold matrices for the CMYK-separations to obtain the binary image data H. The dot pattern generator 18 converts the obtained binary image data H into the binary dot patterns for the CMYK-separations. Each of dot patterns for the CMYK-separations is FFTed (transformed using fast Fourier transform) from an image in the spatial domain to a two-dimensional image in the frequency domain. Then, the transformed two-dimensional images in the frequency domain for the CMYK-separations are substantially elliptical figures. Also, the directions of the major axes of the substantially elliptical figures for the CMYK-separations differ from each other. Specifically, the transformed two-dimensional images for the CMYK-separations are shown as the frequency-domain data AFFT2(1.5, 45°: C) in FIG. 8, the frequency-domain data AFFT2(1.5, 22.5°: M) in FIG. 6, the frequency-domain data AFFT2(1.5, 0°: Y) in FIG. 4 and the frequency-domain data AFFT2(1.5, 67.5°: K) in FIG. 10, for example. The four substantially elliptical figures are congruent with each other. The directions of the major axes of the substantially elliptical figures for the CMYK-separations are 45°, 22.5°, 0° and 67.5°, respectively.

In this case, angles between the major axes of the substantially elliptical figures for the CMYK-separations are 22.5°. Since the Y separation is not so strong, it is effective that angles between the major axes of the substantially elliptical figures for the CMK-separations may be 30°.

For example, in the substantially elliptical figures for the CMYK-separations, the angles between the major axes of the substantially elliptical figures for the CMK-separations may differ from each other by 30°. That is, the frequency-domain data AFFT2 for the C-separation may have the slope θ of 15°, the frequency-domain data AFFT2 for the M-separation may have the slope θ of 45° (135°), and the frequency-domain data AFFT2 for the K-separation may have the slope θ of 75°.

In the above embodiment, the flattening f (ellipticity) of the ellipses is 1.5. Further, it has been confirmed that the graininess can be reduced when the flattening f is in the range from 1.1 to 3.0 (Specifically, it is confirmed when the value f is 1.1, 1.25, 1.5, 2 and 3, respectively).

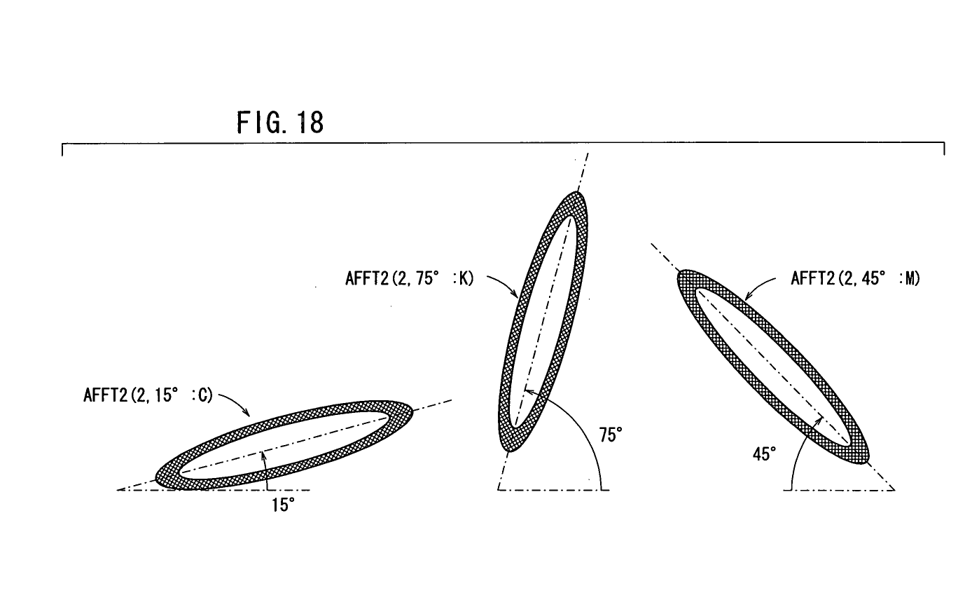

FIG. 18 illustrates the frequency-domain data AFFT2 (2, 15°: C), AFFT2 (2, 45°: M), and AFFT2 (2, 75°: K). In this example, the frequency-domain data AFFT2 for the C-separation have the slope θ of 15°, the frequency-domain data AFFT2 for the M-separation have the slope θ of 45° (135°), and the frequency-domain data AFFT2 for the K-separation have the slope θ of 75°. In the substantially elliptical figures for the CMYK-separations, the angles between the major axes of the substantially elliptical figures for the CMK-separations may be 30°.

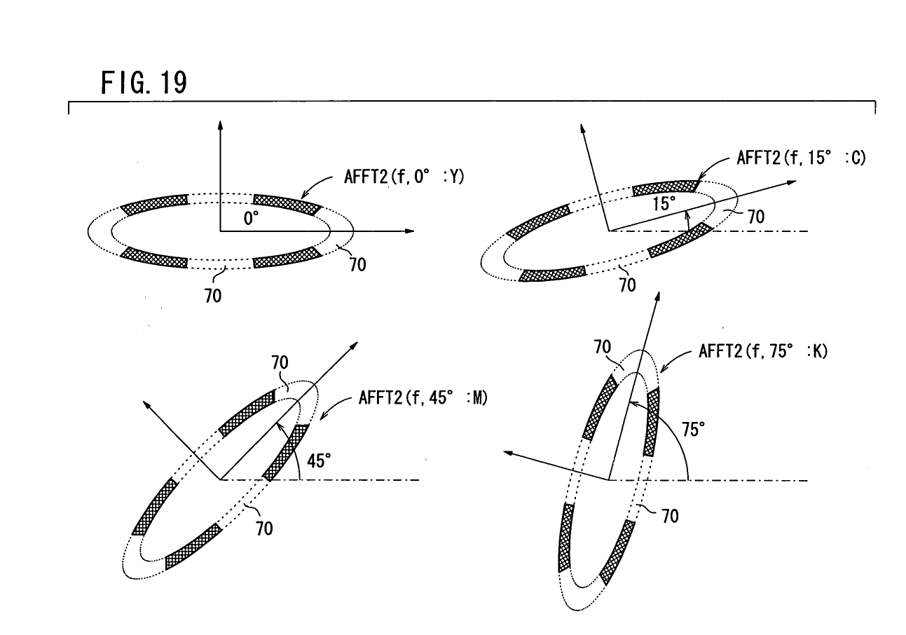

Further, as shown in FIG. 19, it has been confirmed that there may be some gaps in the substantially elliptical figures. In this example, the frequency-domain data AFFT2 (f, 0°: Y) for the Y separation, AFFT2 (f, 15°: C) for the C separation, AFFT2 (f, 45°: M) for the M separation, and AFFT2 (f, 75°: K) for the K separation are shown, in which there are gaps 70 in each of the substantially elliptical figures in the directions of major and minor axes, respectively.

For example, a set of the threshold matrices thus generated will be used as follows.

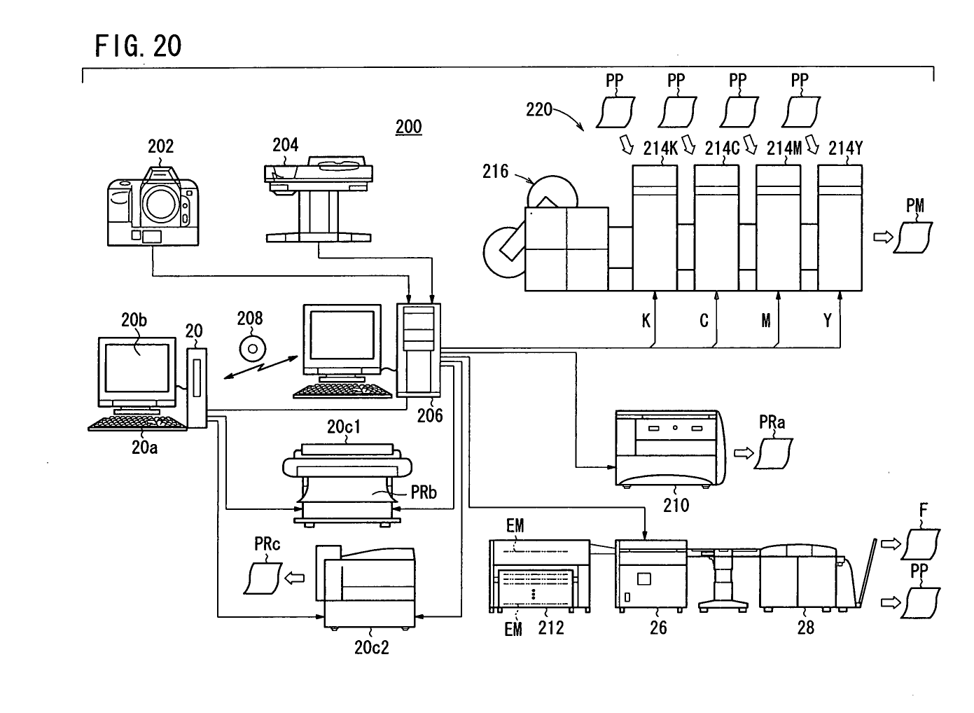

FIG. 20 shows a printing/platemaking system 200 incorporating a set of threshold matrices TM generated by the threshold matrix generating apparatus 20 of the threshold matrix generating system 10 shown in FIG. 1.

In the printing/platemaking system 200, RGB image data captured by a digital camera 202 as an image capturing unit or RGB image data (or CMYK image data) read by a plate input machine 204 as a scanner (image reader) are supplied to an RIP (Raster Image Processor) 206, which converts the RGB image data into CMYK image data. The digital camera 202 and the plate input machine 204 correspond to the input unit 20a shown in FIG. 1.

The RIP 206 stores in its hard disk the data of threshold matrices TM (threshold matrix data) generated by the threshold matrix generating apparatus 20 and supplied through an optical disk 208 serving as a recording medium such as a CD-R or the like or through a communication link.

The RIP 206 compares the CMYK image data and the corresponding CMYK threshold matrix data, respectively, and converts the CMYK image data into CMYK dot pattern data (CMYK image data).

The CMYK dot pattern data are then sent to a DDCP (Direct Digital Color Proofer) 210, which produces a print proof PRa on a sheet of paper. The DDCP 210 allows the operator to confirm noise components and printing quality on the print proof PRa before the image data are processed by a printing press 220. The sheet of paper used by the DDCP 210 may be a sheet of printing paper used by the printing press 220.

The RIP 206 delivers the CMYK dot pattern data to a color ink jet printer 20c1 which produces a printing proof PRb on a sheet of paper or a color electrophotographic printer 20c2 which produces a printing proof PRc on a sheet of paper.

The CMYK dot pattern data are also sent to the exposure unit 26 which serves as a filmsetter or a platesetter in the output system 22 such as a CTC apparatus or the like. If the exposure unit 26 is a filmsetter, the automatic developing machine 28 generates a film F. The film F is superposed on a printing plate material, and exposed to light by a planar exposure unit (not shown), producing a printing plate PP. If the exposure unit 26 is a platesetter as shown in FIG. 1, then the automatic developing machine 28 directly outputs a printing plate PP. The exposure unit 26 is supplied with printing plate materials EM or the like from a magazine 212 of photosensitive materials (including plate materials).

CMYK printing plates PP are mounted on plate cylinders (not shown) in a K-separation printer 214K, a C-separation printer 214C, an M-separation printer 214M, and a Y-separation printer 214Y of the printing press 220. In the K-separation printer 214K, the C-separation printer 214C, the M-separation printer 214M, and the Y-separation printer 214Y, the CMYK printing plates PP are pressed against a sheet of printing paper supplied from a printing paper supply unit 216 to transfer the inks to the sheet of printing paper, thereby producing a printed material PM on which a color image is reproduced. If the printing press 220 is configured as a CTC apparatus, then the RIP 206 supplies the CMYK dot pattern data directly through a communication link, and the printing plates mounted on the plate cylinders are exposed to record image data and then developed directly into printing plates PP.

Although certain preferred embodiments of the present invention have been shown and described in detail, it should be understood that various changes and modifications may be made therein without departing from the scope of the appended claims.

What is claimed is:

1. A dot pattern forming apparatus for converting a continuous-tone image into binary dot patterns for color separations of a multiple color image by FM screen threshold matrices for the separations of the multiple color image,
wherein when a middle tone image of uniform density is converted into the binary dot patterns for the separations of the multiple color image by the FM screen threshold matrices for the separations of the multiple color image, and when each of dot patterns for at least two separations in the converted binary dot patterns is FFTed from an image in spatial domain to a two-dimensional image in frequency domain, the transformed two-dimensional images for at least the two separations are substantially elliptical figures,
each of the substantially elliptical figures includes an ellipse and a figure that is not a circle or a rectangle but is symmetrical with respect to straight lines of major and minor axes orthogonal to each other and that has a smooth curvature along the entire periphery of the figure, and
the directions of the major axes of the substantially elliptical figures for at least the two separations differ from each other.

2. An apparatus according to claim 1, wherein color of the multiple color image is formed by C, M, Y and K.

3. An apparatus according to claim 1, wherein at least the two separations are a C-separation and an M-separation.

4. An apparatus according to claim 3, wherein major axes of the substantially elliptical figures for the C-separation and the M-separation are orthogonal to each other.

5. An apparatus according to claim 1, wherein the substantially elliptical figures are congruent with each other.

6. A dot pattern forming apparatus for converting a continuous-tone image into binary dot patterns for CMYK-separations by FM screen threshold matrices for the CMYK-separations,
wherein when a middle tone image of uniform density is converted into the binary dot patterns for the CMYK-separations by the FM screen threshold matrices for the CMYK-separations, and when each of the converted binary dot patterns is FFTed from an image in spatial domain to a two-dimensional image in frequency domain, the transformed two-dimensional images for the CMYK-separations are substantially elliptical figures,
each of the substantially elliptical figures includes an ellipse and a figure that is not a circle or a rectangle but is symmetrical with respect to straight lines of major and minor axes orthogonal to each other and that has a smooth curvature along the entire periphery of the figure, and
the directions of the major axes of the substantially elliptical figures for the CMYK-separations differ from each other.

7. An apparatus according to claim 6, wherein angles between the major axes of the substantially elliptical figures for the CMK-separations are 30°.

8. An apparatus according to claim 6, wherein angles between the major axes of the substantially elliptical figures for the CMYK-separations are 22.5°.

9. An apparatus according to claim 6, wherein the major axes of the substantially elliptical figures for the CM-separations are orthogonal to each other.

10. An apparatus according to claim 6, wherein the substantially elliptical figures are congruent with each other.

11. A set of FM screen threshold matrices for color separations of a multiple color image, for converting a continuous-tone image into binary dot patterns for the separations of the multiple color image,
wherein when a middle tone image of uniform density is converted into the binary dot patterns for the separations of the multiple color image by the FM screen threshold matrices, and when each of dot patterns for at least two separations in the converted binary dot patterns is FFTed from an image in spatial domain to a two-dimensional image in frequency domain, the transformed two-dimensional images for at least the two separations are substantially elliptical figures,
each of the substantially elliptical figures includes an ellipse and a figure that is not a circle or a rectangle but is symmetrical with respect to straight lines of major and minor axes orthogonal to each other and that has a smooth curvature along the entire periphery of the figure, and
the directions of the major axes of the substantially elliptical figures for at least the two separations differ from each other.

12. A set of threshold matrices according to claim 11, wherein color of the multiple color image is formed by C, M, Y and K.

13. A set of threshold matrices according to claim 11, wherein at least the two separations are a C-separation and an M-separation.

14. A set of threshold matrices according to claim 13, wherein major axes of the substantially elliptical figures for the C-separation and the M-separation are orthogonal to each other.

15. A set of threshold matrices according to claim 11, wherein the substantially elliptical figures are congruent with each other.

16. A set of FM screen threshold matrices for CMYK-separations, for converting a continuous-tone image into binary dot patterns for the CMYK-separations,
wherein when a middle tone image of uniform density is converted into the binary dot patterns for the CMYK-separations by the FM screen threshold matrices, and when each of the converted binary dot patterns is FFTed from an image in spatial domain to a two-dimensional image in frequency domain, the transformed two-dimensional images for the CMYK-separations are substantially elliptical figures,
each of the substantially elliptical figures includes an ellipse and a figure that is not a circle or a rectangle but is symmetrical with respect to straight lines of major and minor axes orthogonal to each other and that has a smooth curvature along the entire periphery of the figure, and
the directions of the major axes of the substantially elliptical figures for the CMYK-separations differ from each other.

17. A set of threshold matrices according to claim 16, wherein angles between the major axes of the substantially elliptical figures for the CMK-separations are 30°.

18. A set of threshold matrices according to claim 16, wherein angles between the major axes of the substantially elliptical figures for the CMYK-separations are 22.5°.

19. A set of threshold matrices according to claim 16, wherein the major axes of the substantially elliptical figures for the CM-separations are orthogonal to each other.

20. A set of threshold matrices according to claim 16, wherein the substantially elliptical figures are congruent with each other.
